(19) United States
(12) Patent Application Publication
(10) Pub. No.: US 2015/0042260 A1
(43) Pub. Date: Feb. 12, 2015

(54) ELECTRICAL SOLUTION FOR SAVING POWER AND EXPENSES

(71) Applicant: Harry N. STURM, West Bloomfield, MI (US)

(72) Inventor: Harry N. Sturm, West Bloomfield, MI (US)

(21) Appl. No.: 14/382,655

(22) PCT Filed: Mar. 4, 2013
(86) PCT No.: PCT/US13/28941

§ 371 Date: Sep. 3, 2014

Related U.S. Application Data
(60) Provisional application No. 61/606,406, filed on Mar. 3, 2012.

(51) Int. Cl. H02P 21/00

(52) U.S. Cl. CPC H02P 21/0035
USPC 318/729

(57) ABSTRACT

An energy-saving device utilizing starting, running and power factor capacitors to operate at least one induction motor where the required input energy is significantly less than the generated output current. The capacitor configuration encourages the addition of more induction motors, whereby even as its electrical output increases, the necessary input current decreases dramatically. Such a device can save up to 90% of the energy requirements, while yielding an ever increasing amount of electrical output. The device is disclosed, along with methods of using it, and a method and device for automatically adjusting the device to either maximum energy savings or maximum energy output.

### CROSS-REFERENCE TO RELATED APPLICATIONS

This application claims the benefit under 35 U.S.C. 119(e) of U.S. Provisional Application No. 61/606,406 filed on Mar. 3, 2012.

### BACKGROUND OF THE INVENTION

1. Field of the Invention

The present invention relates to an electricity saving device, methods of manufacturing same, and methods of using and adjusting the same. More particularly, the invention relates to energy saving devices including the use of combinations of additional capacitor banks above and beyond power factor capacitors in conjunction with at least one induction motor to produce power with greatly reduced electrical input requirements.

2. Description of the Prior Art

Although consumers of electrical power have used power factor configurations in the past to save about 10-15% of energy usage, every industrial consumer of electrical energy wants even more savings and wishes they could more significantly cut down their energy costs to operate their plants or business. Similarly, every residential application could benefit from lower energy bills. As mentioned above, in the past, many businesses have lowered their electrical usage through the implementation of installing a power factor system. The popularity of residential power factor applications has been increasing lately, as well, due to ever increasingly higher electrical bills. Typically, power factor installations using power factor type capacitors can realize between 5% to 20% reduction in electrical usage. However, practitioners of the inventions of those prior art power factor inventions would like to realize even a greater reduction in electrical usage. Obviously, electrical consumers would like to save even more electricity to reduce their energy bills.

Previously, another type of prior art energy saving device was disclosed that included three phase converters which utilize a bank of three-phase capacitors in parallel, where each of the capacitors was put into electrical communication to create a number of single phases connections. In these prior art three phase converter situations, even though the same number of amps was used, single phase connections were created. Again, consumers not only want to convert their energy, they want to save energy as well.

It would be desirable to consumers if there was provided a truly adjustable electrical consumption reduction device, a method of making such a device, as well as a method of using and adjusting the device to maximize electrical consumption.

### SUMMARY OF THE INVENTION

In accordance with the above-noted desires of the industry, the present invention provides various aspects, including a novel combination of varying types of capacitors used in a parallel configuration that significantly consumes less amperage from the wall in order to create a much larger amount of electrical output. In addition to the energy savings, a single phase circuit can be transformed into a three phase circuit by using any available single phase and creating the three phases by utilizing the two leads from the single phase and incorporating a bank of various types of capacitors which provide a third lead to save electricity. This configuration yields a three phase circuit that utilizes much less energy than previously experienced. Further, there is disclosed a method of making same, and a method of adjusting and using the newly created three phase circuit while minimizing the electrical input requirement. This also includes a disclosure of a three phase circuit that has been tailor-made to optimize either energy output or minimized energy requirements.

These new electrical circuits and the methods of selecting and using the circuits overcome some of the aforementioned problems with the power factor correction circuit prior art because the prior art teaches new circuits that only reduce energy requirements by 5% to a maximum of about 20%, whereas the present invention teaches new circuits that reduce energy consumption from about 50% up to over 94% energy savings, depending on the selections made by the engineer. Depending upon capacitor selections tailor made for specific applications, the energy savings may either slightly increase or decrease. Clearly, this is a significant development that could be utilized to save huge amounts of energy and save power plant emission gases, along with many other benefits.

Although the above mentioned conventional power factor applications were well known in the art, including one of the most common types of power factor capacitor banks, new and novel combinations of parallel circuits of various types and values of capacitor banks are capable of much more significantly reducing electrical amperage requirements. The inventor believes that such an adjustable system of various capacitor banks to save energy have not been known heretofore.

One should be made aware that the amperage and the voltage can be adjusted and manipulated by varying the number and type of capacitors, as long as you do not go over the rating of the motor. Preferably, to prolong the life of the motor, one should stay within 80% of the recommended rating of the motor.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings described briefly below, in which like parts are given the same reference numerals, and wherein said drawings include:

FIG. 1 is a first aspect of an electrical circuit diagram view of a new three phase circuit made in accordance with the present invention;

FIG. 2 diagrammatically details a second aspect of the present invention;

FIG. 3 is a representation of a third example and aspect of the present invention for a 50 and 75 HP motor combination;

FIG. 4 is a representation of a fourth example and aspect of the present invention for a 50 and 75 HP motor combination utilizing a transformer

FIG. 5 is a representation of a fifth example and aspect of the present invention for a 50 and 75 HP motor combination with a transformer;

FIG. 6 is a representation of a sixth example and aspect of the present invention for two (2) 50 HP motors and a 75 HP motor, all three in combination with a transformer;

FIG. 7 is a representation of a seventh example and aspect of the present invention for two (2) 50 HP motors and a 75 HP motor, all three in combination with a transformer;

FIG. 8 is a representation of an eighth example and aspect of the present invention for one 7.5 HP three phase induction motor with a particular capacitor configuration yielding an extremely low power usage;

FIG. 9 is a representation of a ninth example and aspect of the present invention for one 7.5 HP three phase induction motor with a particular capacitor configuration yielding an extremely low power usage;

FIG. 10 is a representation of a tenth example and aspect of the present invention for, still once again, a single 7.5 HP three phase induction motor with a particular capacitor configuration yielding an extremely low power usage;

FIG. 11 is a representation of an eleventh example and aspect of the present invention for two (2) motors, i.e. a single phase 15 HP and a three phase 75 HP motor, both in combination with a transformer;

FIG. 12 is a representation of a twelfth example and aspect of the present invention for one 75 HP three phase induction motor with a particular capacitor configuration yielding an extremely low power usage;

FIG. 13 is a representation of yet a thirteenth example and aspect of the present invention for one 75 HP three phase induction motor with a different capacitor configuration yielding an extremely low power usage;

FIG. 14 is a diagram of the algorithm steps detailing the adjustment circuit;

FIG. 15 is a graph of the amperage charted against the line capacitors use during the adjustment circuit aspect;

FIG. 16 is a circuit diagram illustrating the relative connection of the capacitors and the other components;

FIG. 17 is a chart of the capacitors used in line to achieve a minimum amperage value;

FIG. 18 is an illustration of all relative components and their electrical connections;

FIG. 19 is a representation of the various components in accordance with the present invention;

FIG. 20 is a side elevational view of all components in the electrical circuit cabinet;

FIG. 21 is a top plan view of the capacitor and electrical component configuration within the cabinet;

FIG. 22 is a screenshot of the initial standby mode;

FIG. 23 is a second screenshot of the start sequence initiator; and

FIG. 24 is the last screenshot once the system is to, relaying the input current and output current in amps.

Reference will now be made to a detailed description about various specific aspects of the invention. While the invention will be described in conjunction with these specific aspects, it will be understood that they are not intended to limit the invention to one aspect. On the contrary, they are intended to cover alternatives, modifications, and equivalents as may be included within the spirit and scope of the invention as defined by the appended claims. In the following description, numerous specific details are set forth in order to provide a thorough understanding of the present invention, the energy savings that can be realized, and the manner in which the adjustability of the electrical circuit yields the most energy savings possible. The present invention may be practiced without some or all of these specific details. In other instances, well known process operations have not been described in detail in order not to unnecessarily obscure the present invention.

### DETAILED DESCRIPTION OF THE INVENTION

In accordance with the present invention, an energy-saving device is disclosed which utilizes banks of passengers in an adjustable relationship to minimize the energy usage while operating. The described electrical circuits have been tried and have been shown to successfully and dramatically reduce the power usage from the grid.

Although the mechanism is not fully understood as to how the electrical usage is reduced so dramatically, I was able to achieve such dramatic reductions in usage reliably and predictably by practicing the following invention detailed in the examples. By re-configuring the various capacitor components, an operator can either increase the power output or the operator can maximize the power savings by making adjustments to the electrical circuit configuration. The electric energy-saving device can be made completely automatically adjustable, and therefore can be automatically optimized to maximize power output or to maximize power savings. Noting the below examples, one can see the trends, and the present invention will predictably adjust the electrical usage in savings.

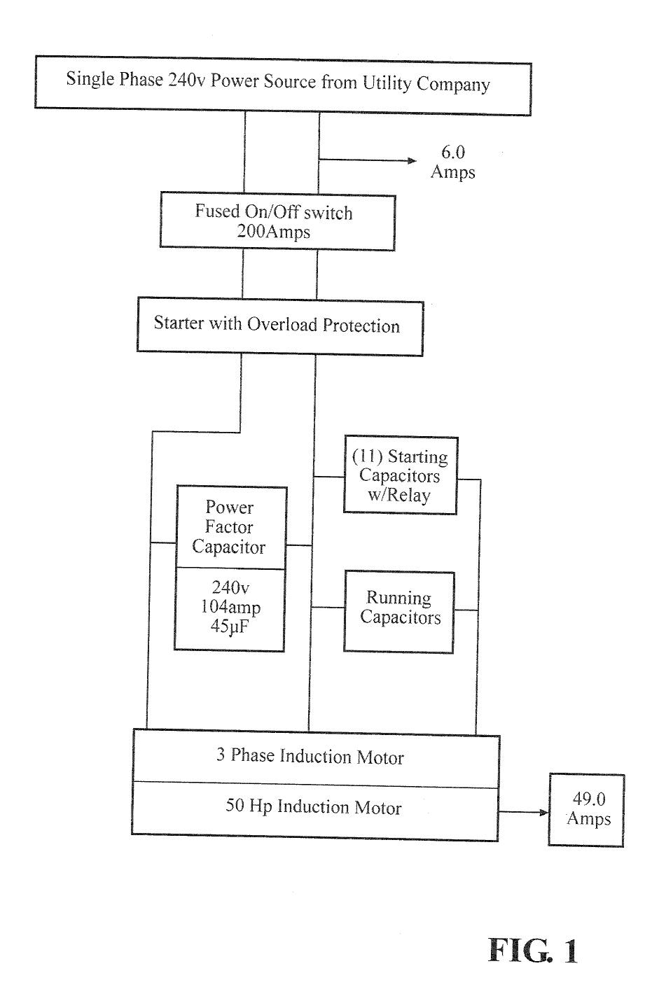

Referring now to the drawings in detail, FIG. 1 is an electrical circuit diagram of a new three phase circuit generally indicated by the numeral 10, which also includes a first and second lead coming from the original single phase circuit. The leads from the single phase circuit are in electrical communication with a bank of capacitors generally indicated as numeral 12. As noted above here, after the starter, the two leads of the single phase run through the capacitor combination, yielding a three wire, three phase lead for connecting to at least one three phase induction motor.

FIG. 1 is shown as using a starter with overload protection, preferably an Allen Bradley starter, commercially available from Rockwell Automation Corporation of Milwaukee Wis. From the two leads exiting the starter, a combination of capacitors, incorporating a 240 Volt, 104 Amp, 45 microfarad power factor capacitor in series with a parallel configuration of eleven (11) Supco™ starting capacitors with relays, sold as Starter Pow-R-Pak™, model SPP6, commercially available from Sealed Unit Parts Co., Inc. of Allenwood, N.J., with various running capacitors.

### Energy Solutions—Saving Power and Expenses

Depending on how much power is needed, one would start with a single phase induction motor, and thereafter produce a third phase by utilizing capacitor banks, where the banks include three types of capacitors, I.e. starting, power and running capacitors. With the starting capacitors and running capacitors in parallel, and both in series with a bank of power factor capacitor(s), a third phase wiring is produced from a two-wire single phase system.

By adding or subtracting various capacitor configurations, one can make as much power out of it as needed, since high voltage is good for motors (low voltage damages motors). One can also develop +/− power configurations from 200 v to 300 v capacitors, as utilization of a 277 v capacitor can produce lighting systems for commercial applications, or 120 v-240 v depending on your capacitor bank. The capacitors can be mixed anywhere from 240 v to 370 v and 480 v capacitor can also be mixed with 5 to 80 microFarads, and all can be mixed together to produce what you desire. This type of system can save more than 50%, or 85-95% of your electric bill depending on what is required.

For example, starting with a 240 v single phase power source, and adding thereafter my prescribed capacitor configuration, one can begin with a first 3 phase 50 HP motor, and then one can add three or more additional 50 hp 3 phase motors, and run them off of the first one. Also, you can install your own power system by installing breaker panels out of each motor etc.

You can also get whatever voltage you need by either adding a transformer to the motor or if you use a 3 phase motor, one can control the voltage by starting the motor in single phase with capacitors and control of one of the three phases by installing the capacitors as noted in Example 2 below. The one phase you produce through the capacitor, which are either 240V to 370V, or maybe either 440V or even a 480V capacitor, depending on what you desire to accomplish. For example, an operator can run a 277V power source for a lighting operation in a commercial building. If the building is powered by 480 V single phase, the lighting system will get 277V to ground. On the other hand, if it is powered by a 240V single phase power source, one must increase it to 277V off the phase being produced off of the motor you started with. Once the voltage is increased, after 277 v is reached, all of the 277 lights can be run off of the motor in that commercial building.

Also, a lot of electricity is saved by controlling the power factor. The perfect power factor is a ratio having a value of 1, although the lower the value of the ratio, the more electrical expenditure there is. For example, 0.1 or 0.2 or 0.3 is a very bad average power factor and simply put, it costs a lot of money. By increasing the power factor to a value as close to 1 as possible, a lot of money is saved. So, it is advantageous to correct the power factor by installing commercially available power factor capacitors. Achieving a power factor as close to 1 as possible by installing those power factor capacitors, for example to 0.85 or 0.9, is almost never accomplished because perfection is difficult to achieve. Savings of 50% or more on your electric bill just by those capacitors alone has not been achievable.

As a further example, we could operate an induction motor running at lamps with a capacitor of 370 v and 5 Microfarads. By replacing the capacitor with running capacitors of 370V, 10 Microfarad, you would get +/−3 or 4 amps. By checking and correcting the power factor, you can get even better results. To set up any system, it is useful to have a volt meter, a power factor meter, and a watt meter. In order to correct the power factor to a value as close to 1 as possible, a perfect sine wave needs to be achieved. Otherwise, expenses will be incurred for all the spikes on the diagram, adding to the expense.

In yet another example, a 10 hp 3 phase induction motor is connected to a 240 v single phase power source with the instant capacitor setup, and is connected with a pulley or gear to a 10 or 15 hp single phase. In order to be able to make a generator out of a motor, it appears you can only do it mechanically because it you attempted to do it electrically, you wouldn't be able to speed up the motor over 1800 rpm. So by installing special gearing or a different pulley over one of the motors, you could set it up to increase the rpm's.

In some aspects of my invention, there are at least a series of starting capacitors, a variety of running capacitors, and at least one power factor capacitor with all different voltages for all different motors. Different systems exhibiting all limited power voltages are available depending upon how your capacitor(s) and transformers are connected. A single phase 240V power source, including a single phase 240 volt power source from a utility company, can be converted into a three phase system that exhibits incredible energy conservations when attached to induction motors, can yield up to a 95% reduction in energy usage for a particular set of small to large horsepower motors under full load.

In order to convert the single phase voltage power source to a three phase induction motor source, we need to electrically connect a bank of capacitors having a particular configuration for a reduction of electrical usage. These various capacitor configurations are described in more detail hereinbelow.

Initially, we were able to start a 50 hp 3 phase induction motor using a power source of single phase 240V with a power capacitor. Then, a 15 hp single phase motor was added to the 50 HP motor, and then yet another 75 hp 3 phase induction motor was added, again all initially connected to the single phase 240V power source from the wall. Then, test results were achieved using a transformer connected to a power source of 480 v 3 phase in the building, causing a transformation to 240 v. The transformer itself was pulling about 10-12 amps. As before, we started a 50 HP motor initially, then added the 15 HP single phase motor, and then followed that by adding the 75 HP motor. By adding the power factor capacitor to the motors, the total system, with all those motors put together, the power usage drawn from the 50 HP motor was measured at 8 amps, the 15 HP motor was measured at 60 amps, while the 75 HP motor was measured at 118 amps. Total output of the whole system was between 5-30 amps. Now if you add a few more starting and running capacitors in my particular configuration, test results will show that you experience approximately 6 amps on the total load.

An induction three phase motor was started on a power source of single phase 240, and a 50 hp motor 240V was running at 6 amps where we did the test. The various capacitors used are listed here:
(11)—Supco starting capacitors, with a built in relay
(3)—Running capacitors of 370 v, 80 Microfarad
(3)—Running capacitors of 440 v, 45 Microfarad
(1)—Power Factor Capacitor of 480 v, 42 Microfarad
(1)—Running Capacitor of 370 v, 5 Microfarad
(5)—Running Capacitors of 440 v, 70 Microfarad

The result of this electrical configuration was that the 240 v 50 HP induction motor was pulling approximately 6 amps. The second it goes from the total load, which was 104 Amps to get it started, and after you hook up all three motors together, you come up with 6 amps at the power source.

Another example using a 50 HP motor 240 v, we achieved a low power usage of 9 amps by connecting the following configuration of varying types of capacitors:
(13)—Supco starting capacitors, with built-in relays
(6)—Running capacitors of 440 v, 70 Microfarads
(2)—Running capacitors of 370 v, 80 Microfarads
(2)—Power Factor Capacitors of 480 v, 42 Microfarads
(2)—Running capacitors of 370 v, 7.5 Microfarads
(1)—Running capacitor of 370 v, 30 Microfarads
(1)—Running capacitor of 370 v, 5 Microfarads +5, +4, +7.5 Microfarads
(1)—Power Factor Capacitor, 370 v, 10 Microfarads

While the whole thing would be pulling 174 amps, we hooked it up to a 75 HP induction motor while running @ 1180 rpm, 3 phase and then after that the 50hp motor is started. We started with a 480 v power source to the transformer, which was pulling approximately 7 or 8 amps, to achieve 240 v. We got 86 amps on the first motor (Lincoln 50 hp), while the second motor, a 75 hp WEG motor, was pulling 104 amps. When the 75 hp motor starts, it runs at full speed within seconds. The power being used from the grid was only 9 amps. So, by utilizing my capacitor configuration box between the power source from the utility company and the motor(s) that provide power output, we were able to have a power savings of about 94%.

### EXAMPLES

In each of the examples below, a 240V single phase power source from the local utility company was brought into the circuit and a fused on-off 200 amp switch connected to a starter with overload protection. The hot and ground wires come out of the starter and are electrically connected to a particularly configured capacitor bank, which converts the single phase into three phase. Some of the examples use a transformer for the 480V-240V transform, as described more fully hereinbelow with regard to each example, and shown on the example table that tabulates the collective results of thirteen (13) specific examples. Of course, a trend emerges that provides one of ordinary skill in the art with a pattern for either optimizing voltage or power usage, depending upon the capacitor configuration selected. Now we look to the examples:

### Example 1

The electrical diagram of the configuration of capacitors for Example 1. As can be seen in FIG. 1, there is a fused on/off 200 amp switch attached by two wires to the single phase 240 volt power source from the utility company out of the wall. From the fused on/off switch, two wires connect to a starter with overload protection, which is then in turn having its two wires in electrical communication with 5 starting capacitors with relays, 240 volts, where the relays are solid state relays, with hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. 13 Supco™ capacitors are put in parallel with the following configuration of running capacitors: 6 running capacitors of 440 volts, 70 microfarads, 2 running capacitors of 370 volts, 80 microfarads, 1 running capacitor of 370 volts, 30 microfarads, 1 running capacitor of 370 volts, 10 microfarads, 2 running capacitors of 370 volts, 7.5 microfarads, 1 running capacitor of 370 volts, 5 microfarads, and 1 power factor capacitor of 480 volts, 42 microfarads.

This combination of starting capacitors and running capacitors are put into a series connection with a power factor capacitor of 240 volts, 104 amps, 45 microfarads. As can be seen from FIG. 1, there are now 3 wires coming from the capacitor box that has been manufactured, and this is capable of running to an induction as three phase. In this example, I hooked this configuration to a 50 horsepower motor under load, and was producing 49 amps at the motor while drawing only 9 amps from the source.

As can be seen in FIG. 1, there is a fused on/off 200 amp switch attached by two wires to the single phase 240 volt power source from the utility company out of the wall as shown by the electrical diagram of the configuration of capacitors for Example 1. From the fused on/off switch, two wires connect to a starter with overload protection, which is then in turn in electrical communication with starting capacitors with relays, 240 volts, where the relays are solid state relays, with eleven (11) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 11 Supco™ capacitors are put in parallel with the following configuration of running capacitors: 5 running capacitors of 440 volts, 70 microfarads; 2 running capacitors of 370 volts, 80 microfarads; 1 running capacitor of 370 volts, 5 microfarads; and 1 power factor capacitor of 480 volts, 42 microfarads.

This combination of starting capacitors and running capacitors are put into a series connection with a power factor capacitor of 240 volts, 104 amps, 45 microfarads. As can be seen from FIG. 1, there are now 3 wires coming from the capacitor box that has been manufactured, and this is capable of running to an induction motor as a three phase configuration. In this example, I hooked this configuration to a 50 horsepower motor under load, and was producing 49 amps at the motor while drawing only 6 amps from the source.

### Example 2

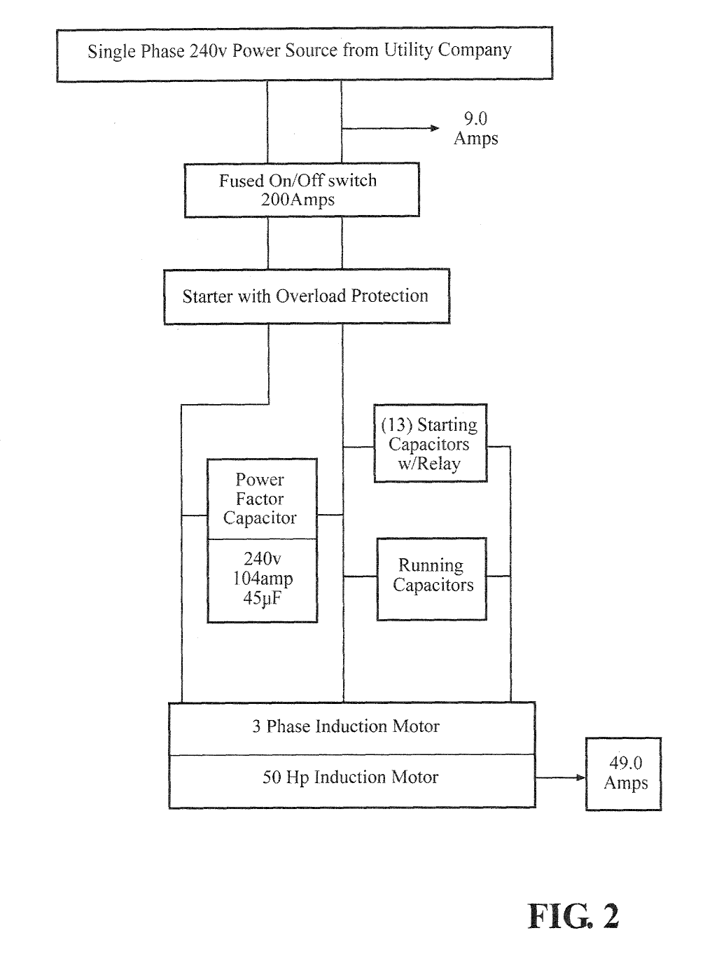

As can be seen in FIG. 2, there is a fused on/off 200 amp switch attached by two wires to the single phase 240 volt power source from the utility company out of the wall as shown by the electrical diagram of the configuration of capacitors for Example 2. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads; and 2 power factor capacitors of 480 volts, 42 microfarads.

This combination of starting capacitors and running capacitors are put into a series connection with a power factor capacitor of 240 volts, 104 amps, 45 microfarads. As can be seen from FIG. 2, there are now 3 wires coming from the capacitor box that has been manufactured, and this is capable of running to an induction as three phase. In this example, I hooked this configuration to a 50 horsepower motor under load, and was producing 49 amps at the motor while drawing only 9 amps from the source.

### Example 3

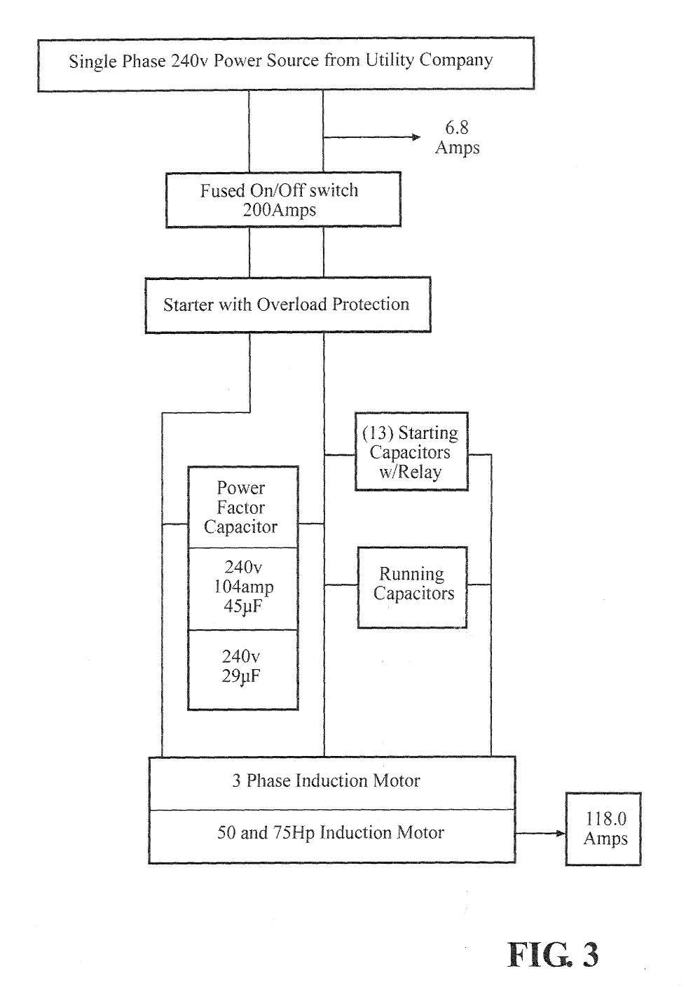

As can be seen in FIG. 3, there is a fused on/off 200 amp switch attached by two wires to the single phase 240 volt power source from the utility company out of the wall as shown by the electrical diagram of the configuration of capacitors for Example 3. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 10 microfarads; and 2 power factor capacitors of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 3, there are now 3 wires coming from the capacitor box that has been manufactured, and this is capable of running to an induction as three phase. In this example, I hooked this configuration to both a 50 and 75 horsepower motor, both under load, and was producing 118 amps at the motor while drawing only 6.8 amps from the source.

### Example 4

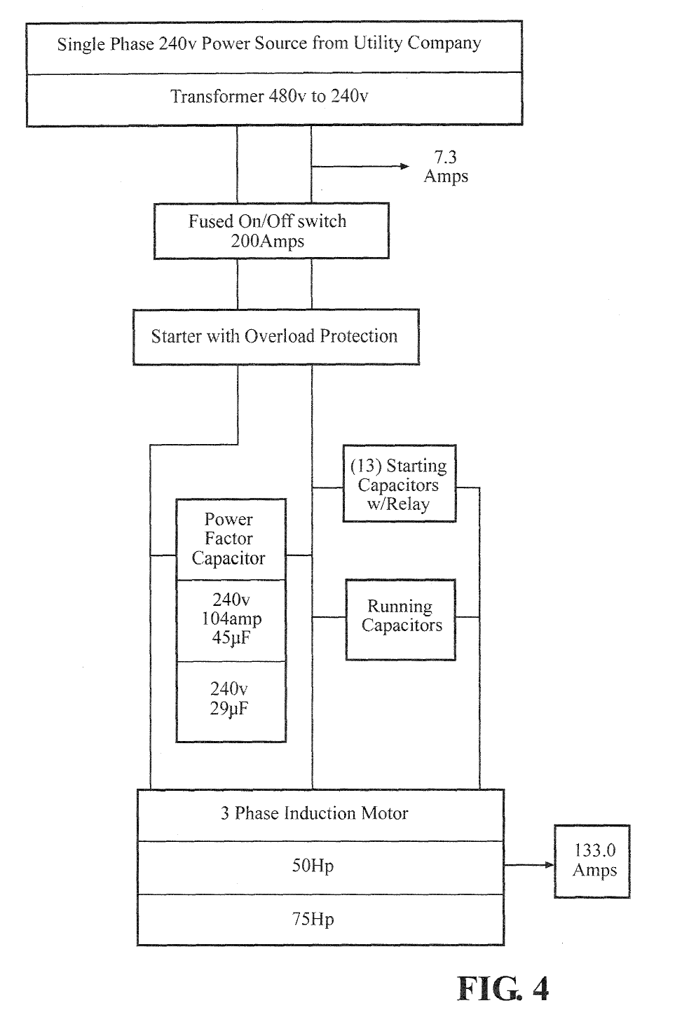

As can be seen in FIG. 4, there is a fused on/off 200 amp switch attached by two wires to the single phase 240 volt power source from the utility company out of the wall, with a transformer of 480 volts to 240 volts, as shown by the electrical diagram of the configuration of capacitors for Example 4. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads, and 2 power factor capacitors of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 4, there are now 3 wires coming from the capacitor box that has been manufactured, and this is capable of running to an induction as three phase. In this example, I hooked this configuration to both a 50 and 75 horsepower motor, both under load, and was producing 133 amps at the motor while drawing only 7.3 amps from the source.

### Example 5

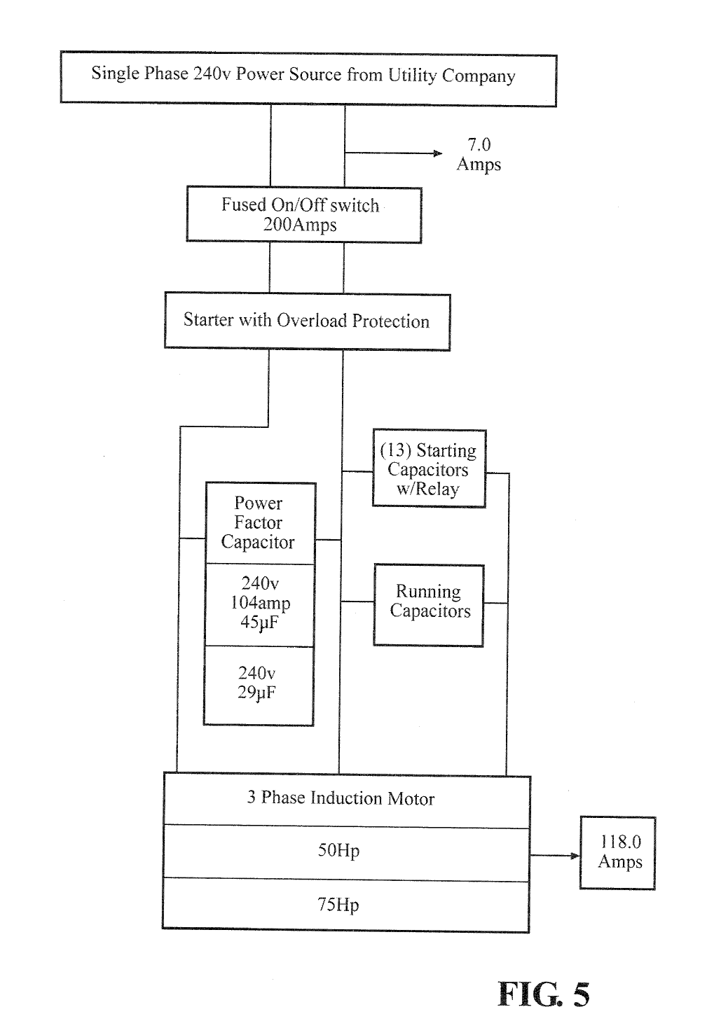

As can be seen in FIG. 5, there is a fused on/off 200 amp switch attached by two wires to the single phase 240 volt power source from the utility company out of the wall as shown by the electrical diagram of the configuration of capacitors for Example 5. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 10 microfarads; and 1 power factor capacitor of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 5, there are now 3 wires coming from the capacitor box that has been manufactured, and this is capable of running to an induction as three phase. In this example, I hooked this configuration to both a 50 and 75 horsepower motor, both under load, and was producing 118 amps at the motor while drawing only 7 amps from the source.

### Example 6

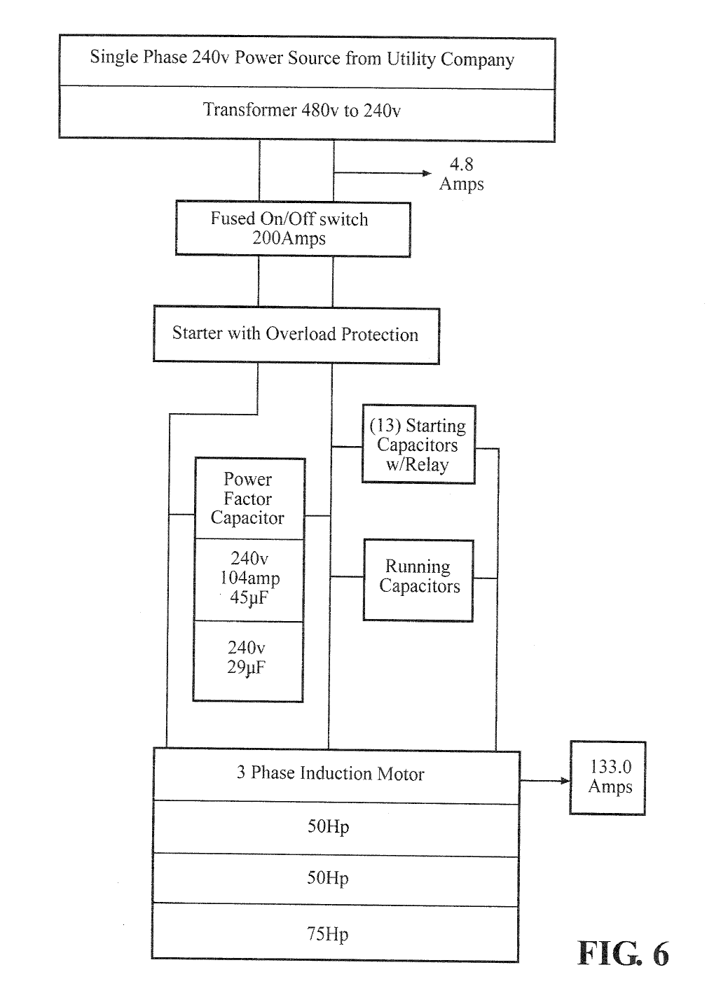

As can be seen in FIG. 6, there is a fused on/off 200 amp switch attached by two wires to the single phase 240 volt power source from the utility company out of the wall, with a transformer of 480 volts to 240 volts, as shown by the electrical diagram of the configuration of capacitors for Example 6. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads; and 2 power factor capacitors of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 6, there are now 3 wires coming from the capacitor box that has been manufactured, and this is capable of running to an induction as three phase. In this example, I hooked this configuration to both a 50 and 75 horsepower motor, both under load, and was producing 133 amps at the motor while drawing only 4.8 amps from the source.

### Example 7

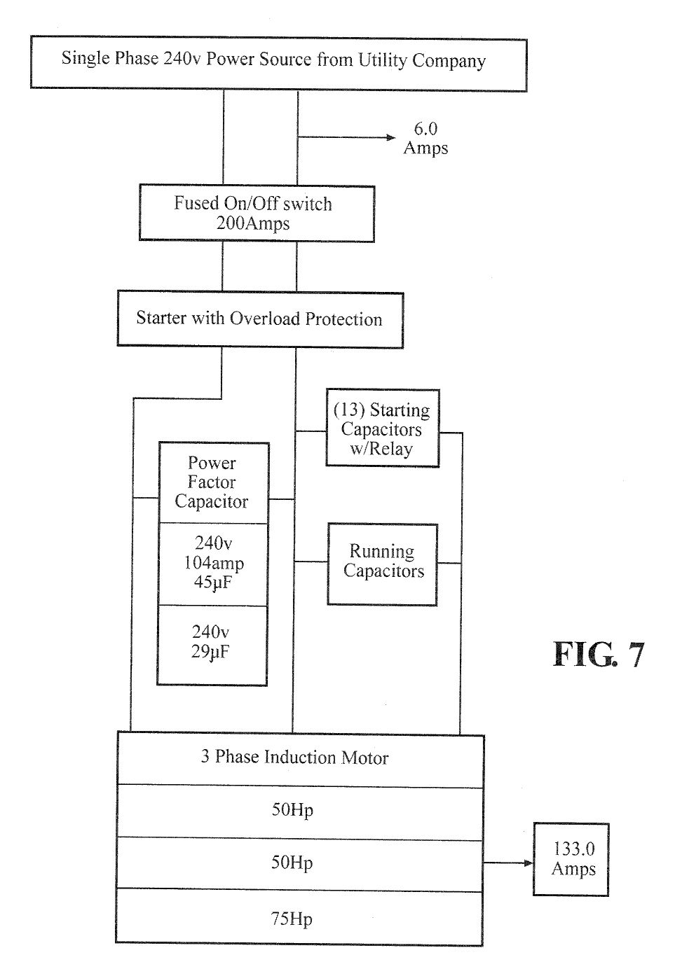

As can be seen in FIG. 7, there is a fused on/off 200 amp switch attached by two wires to the single phase 240 volt power source from the utility company out of the wall as shown by the electrical diagram of the configuration of capacitors for Example 7. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads; and 2 power factor capacitor of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 7, there are now 3 wires coming from the capacitor box that has been manufactured, and this is capable of running to an induction as three phase. In this example, I hooked this configuration to both a 50 and 75 horsepower motor, both under load, and was producing 133 amps at the motor while drawing only 6 amps from the source.

### Example 8

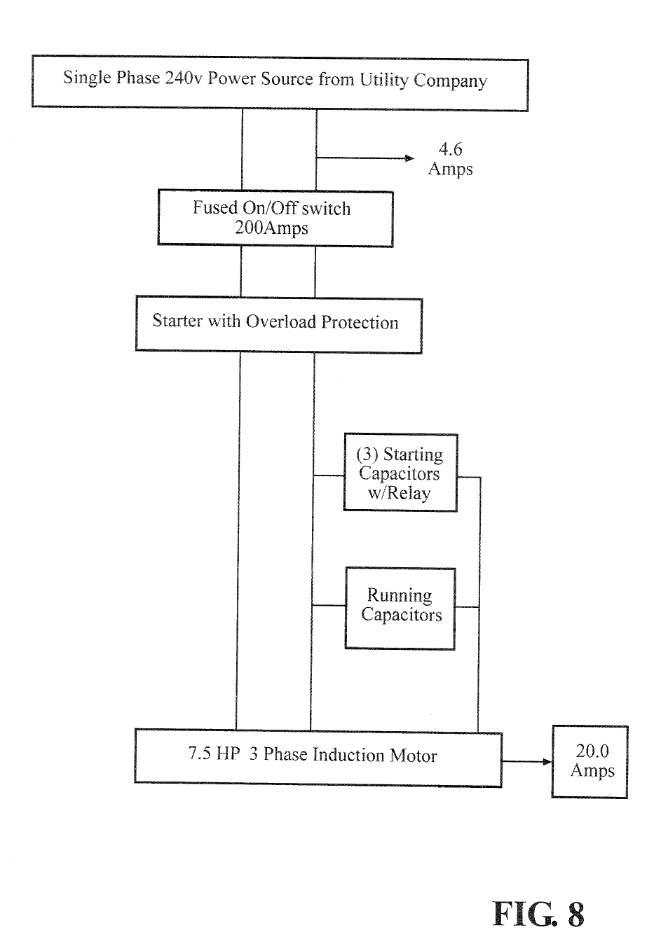

As can be seen in FIG. 8, there is a fused on/off 200 amp switch attached by two wires to the single phase 240 volt power source from the utility company out of the wall as shown by the electrical diagram of the configuration of capacitors for Example 8. From the fused on/off switch, two wires connect to a starter with overload protection, which is then in turn in electrical communication with starting capacitors with relays, 240 volts, where the relays are solid state relays, with three (3) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 1 running capacitors of 440 volts, 70 microfarads; 1 running capacitors of 370 volts, 80 microfarads; and 1 running capacitor of 370 volts, 35 microfarads.

As can be seen from FIG. 8, there are now 3 wires coming from the capacitor box that has been manufactured, and this is capable of running to an induction as three phase. In this example, I hooked this configuration to a 7.5 horsepower motor under load, and was producing 20 amps at the motor while drawing only 4.6 amps from the source.

### Example 9

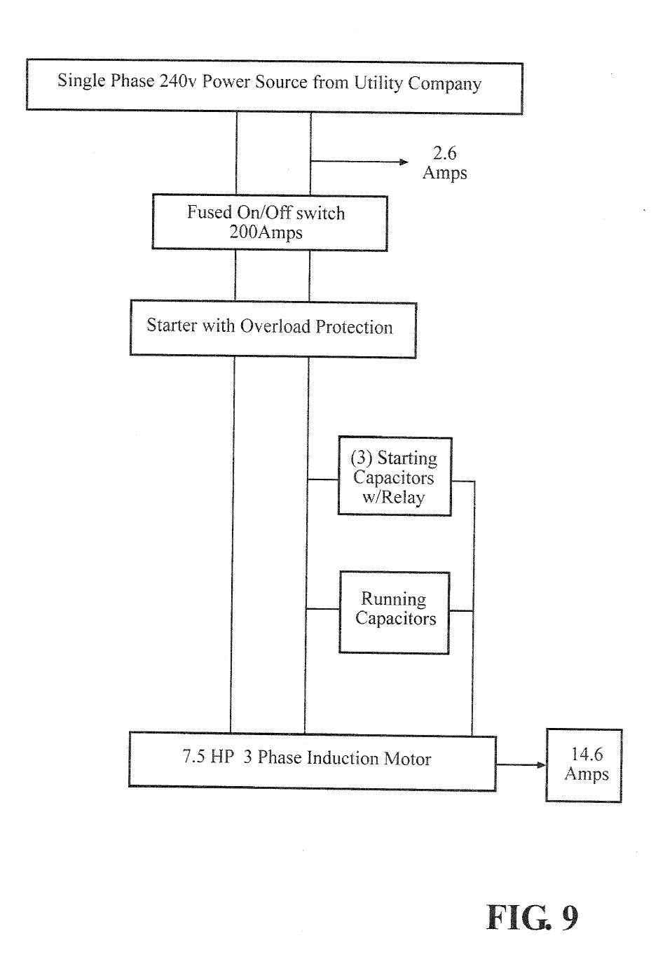

As can be seen in FIG. 9, there is a fused on/off 200 amp switch attached by two wires to the single phase 240 volt power source from the utility company out of the wall as shown by the electrical diagram of the configuration of capacitors for Example 9. From the fused on/off switch, two wires connect to a starter with overload protection, which is then in turn in electrical communication with starting capacitors with relays, 240 volts, where the relays are solid state relays, with three (3) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 1 running capacitors of 440 volts, 70 microfarads; and 1 running capacitors of 370 volts, 80 microfarads.

As can be seen from FIG. 9, there are now 3 wires coming from the capacitor box that has been manufactured, and this is capable of running to an induction as three phase. In this example, I hooked this configuration to a 7.5 horsepower motor under load, and was producing 14.6 amps at the motor while drawing only 2.6 amps from the source.

### Example 10

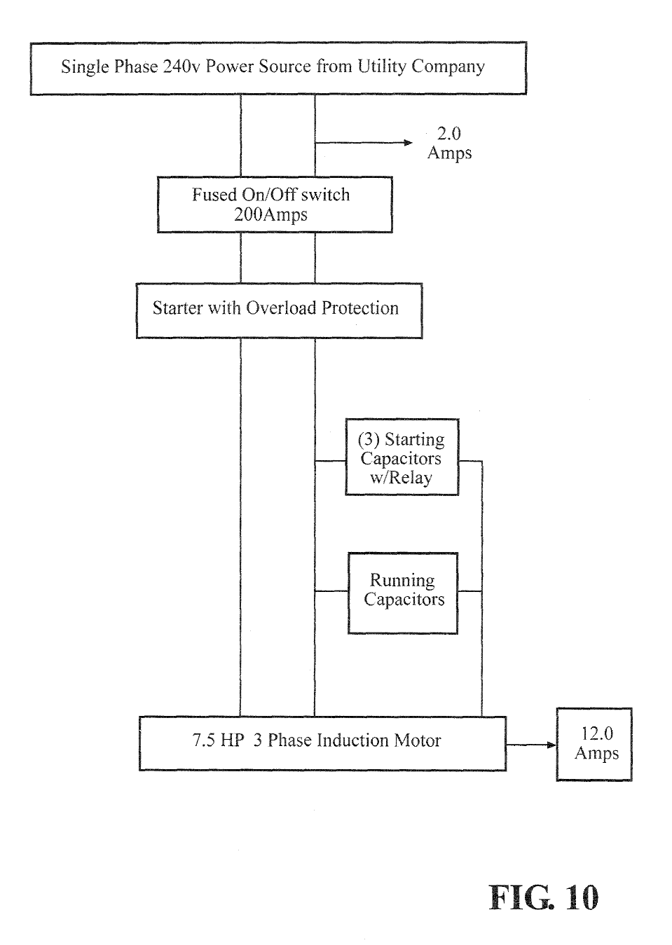

As can be seen in FIG. 10, there is a fused on/off 200 amp switch attached by two wires to the single phase 240 volt power source from the utility company out of the wall as shown by the electrical diagram of the configuration of capacitors for Example 10. From the fused on/off switch, two wires connect to a starter with overload protection, which is then in turn in electrical communication with starting capacitors with relays, 240 volts, where the relays are solid state relays, with three (3) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 1 running capacitors of 440 volts, 70 microfarads; and 1 running capacitor of 370 volts, 35 microfarads.

As can be seen from FIG. 10, there are now 3 wires coming from the capacitor box that has been manufactured, and this is capable of running to an induction as three phase. In this example, I hooked this configuration to a 7.5 horsepower motor under load, and was producing 12 amps at the motor while drawing only 2 amps from the source.

### Example 11

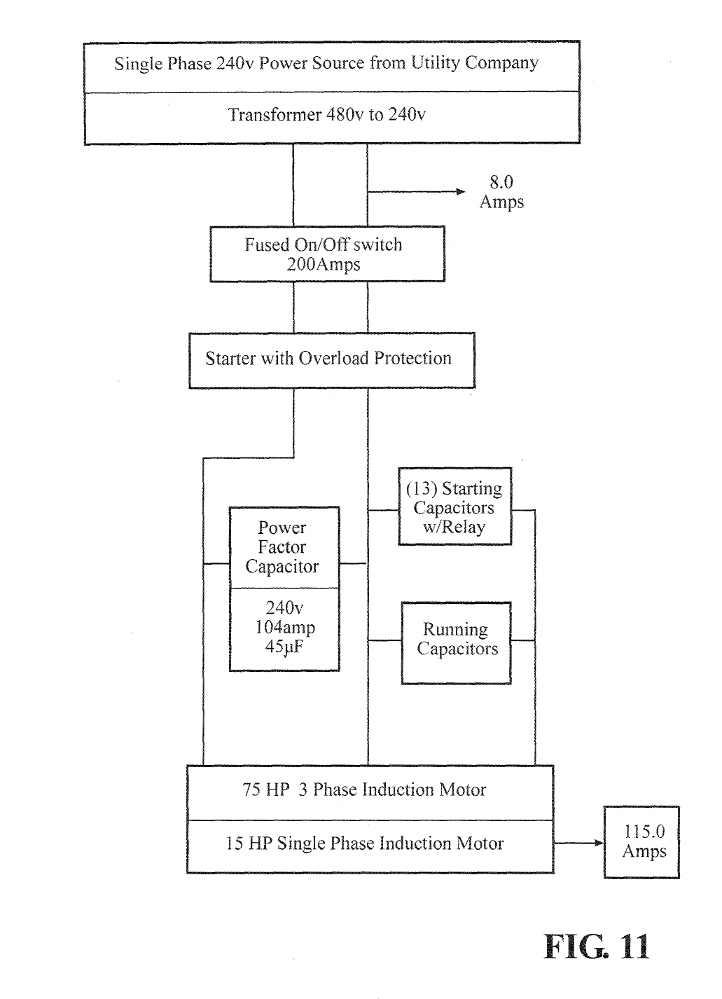

As can be seen in FIG. 11, there is a fused on/off 200 amp switch attached by two wires to the single phase 240 volt power source from the utility company out of the wall, with a transformer of 480 volts to 240 volts, as shown by the electrical diagram of the configuration of capacitors for Example 11. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 10 microfarads; and 2 power factor capacitor of 480 volts, 42 microfarads.

This combination of starting capacitors and running capacitors are put into a series connection with a power factor capacitor of 240 volts, 104 amps, 45 microfarads. As can be seen from FIG. 11, there are now 3 wires coming from the capacitor box that has been manufactured, and this is capable of running to an induction as three phase. In this example, I hooked this configuration to a 75 horsepower motor under load, and a 15 horsepower single phase induction motor and was producing 115 amps at the motor while drawing only 8 amps from the source.

### Example 12

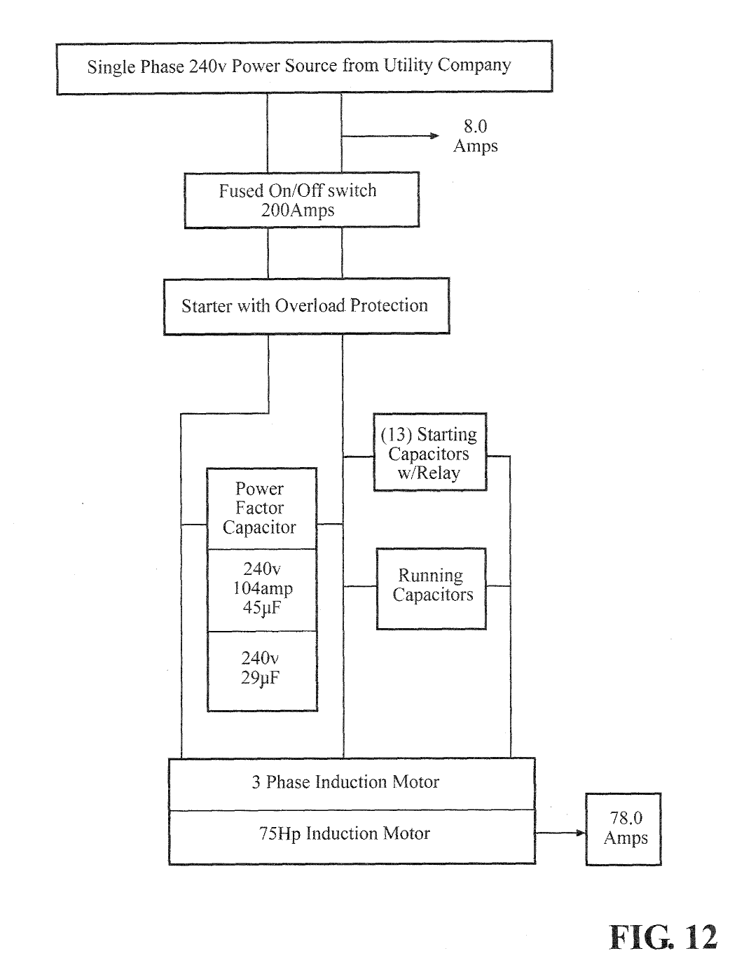

As can be seen in FIG. 12, there is a fused on/off 200 amp switch attached by two wires to the single phase 240 volt power source from the utility company out of the wall as shown by the electrical diagram of the configuration of capacitors for Example 12. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads; and 2 power factor capacitor of 480 volts, 42 microfarads.

This combination of starting capacitors and running capacitors are put into a series connection with a power factor capacitor of 240 volts, 104 amps, 45 microfarads, and a second power factor capacitor of 240 volts, 29 microfarads. As can be seen from FIG. 12, there are now 3 wires coming from the capacitor box that has been manufactured, and this is capable of running to an induction as three phase. In this example, I hooked this configuration to a 75 horsepower motor under load, and was producing 78 amps at the motor while drawing only 8 amps from the source.

### Example 13

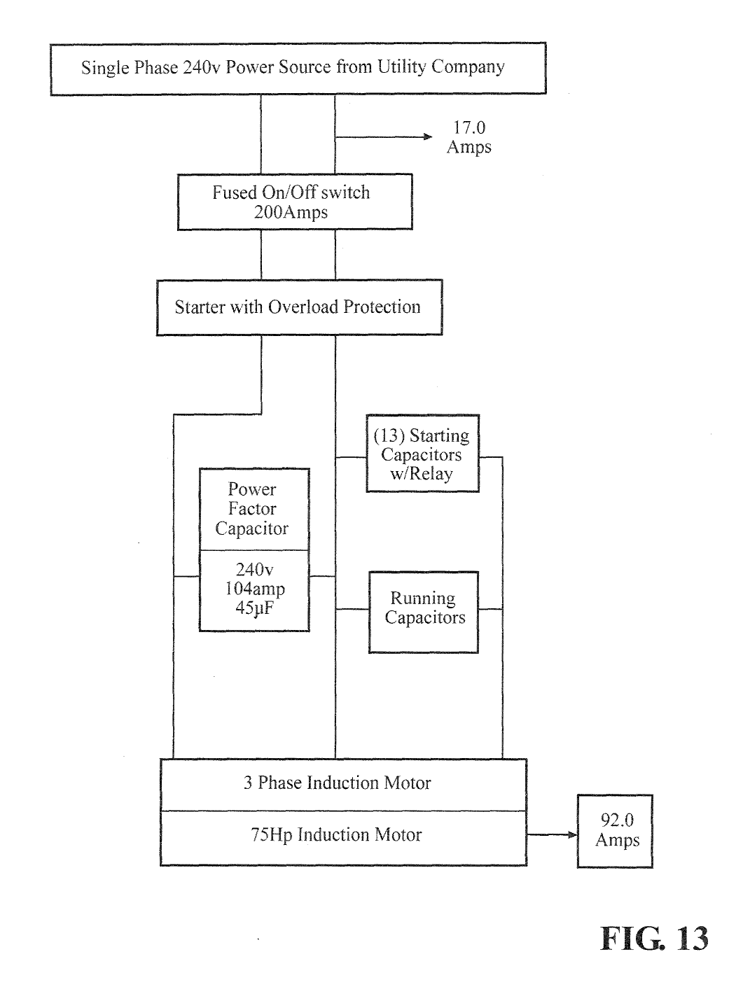

As can be seen in FIG. 13, there is a fused on/off 200 amp switch attached by two wires to the single phase 240 volt power source from the utility company out of the wall as shown by the electrical diagram of the configuration of capacitors for Example 13. From the fused on/off switch, two wires connect to a starter with overload protection, which is then in turn in electrical communication with starting capacitors with relays, 240 volts, where the relays are solid state relays, with thirteen (13) hard start capacitors, such as a Supco™ Starter Pow-R-Pak™ available from Sealed Unit Parts Co. Inc. of Allenwood, N.J., their model SPP6, designed to be used on all PSC single phase 115 volt-288 volt air conditioning units. These 13 Supco™ capacitors are put in parallel with the following configuration of running capacitors: 6 running capacitors of 440 volts, 70 microfarads; 2 running capacitors of 370 volts, 80 microfarads; 2 running capacitors of 370 volts, 7.5 microfarads; 1 running capacitor of 370 volts, 5 microfarads; 1 running capacitor of 370 volts, 30 microfarads; 1 running capacitor of 370 volts, 35 microfarads; 1 running capacitor of 370 volts, 10 microfarads; and 2 power factor capacitor of 480 volts, 42 microfarads.

This combination of starting capacitors and running capacitors are put into a series connection with a power factor capacitor of 240 volts, 104 amps, 45 microfarads. As can be seen from FIG. 13, there are now 3 wires coming from the capacitor box that has been manufactured, and this is capable of running an induction motor as three phase. In this example, I hooked this configuration to a 75 horsepower motor under load, and was producing 92 amps at the motor while drawing only 17 amps from the source. In summary, numerous benefits have been described which result from employing any or all of the concepts and the features of the various specific embodiments of the present invention, or those that are within the scope of the invention. The energy saving box acts to produce a lot of power while only drawing a small fraction of the running power from the utility company.

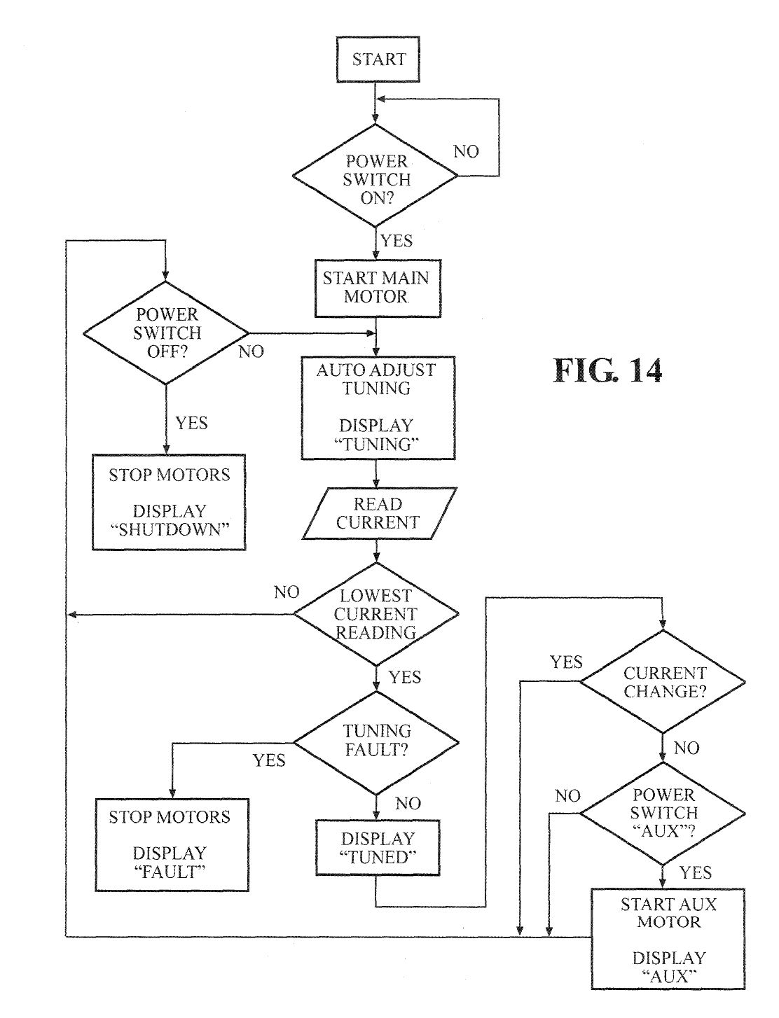

FIG. 14 is a basic logic flow chart illustrating the various tuning steps taken during the automatic adjustment of the configuration of capacitors in order to achieve the lowest possible input of electrical power in order to yield the maximum output from the motors in electrical connection. First, the power switch is turned on which starts the main motor. The auto adjust tuning begins, and the computer screen shows “tuning on”, and the included amp meters read the current until it achieves the lowest current reading. If the lowest current reading is not read, the cycle starts over again to see if the power switch is turned off. Once the lowest current reading has been achieved the next step is to determine if there is a tuning fault and if not, the computer screen displays that is “tuned”. If there is a tuning fault, the motors are stopped and there is a display of the computer screen that says “fault”. Once the tuning has occurred, if there is a change in the current, then the automatic adjustment tuning starts over again in order to achieve the optimum result. If there is no change in the current, then the power automatically switches to auxiliary, which can start the auxiliary motor. Once the motor is started, a display on the computer screen shows “auxiliary”.

This tuning loop algorithmically determines the lowest current input required in order to achieve the maximum output. In another aspect of the present invention, an operator may want a maximum output and that can be algorithmically determined as well. The above examples described manual manipulation of the various capacitor bank configurations in order to achieve optimum performance, while this aspect of the present invention shows at automatic adjustment to achieve the optimum performance, without manual adjustment required by the operator. The manner in which this occurs is described in the following figures.

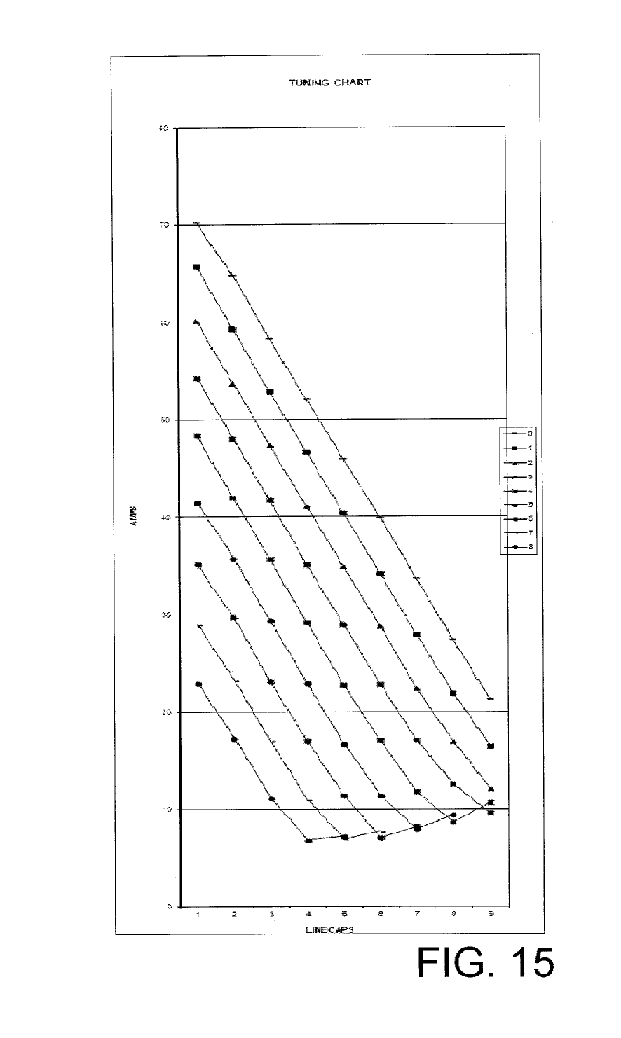

FIG. 15 is a graph of the number of line capacitors vs. amperage resulting from the inclusion of that particular number of line capacitors. These capacitors are electrically connected between varying numbers of line to line capacitors, generally of 100 microfarads, 377 VAC, to any type capacitors. Varying microfarad ratings for these capacitors may be utilized, depending upon the desired end result, so this value of 100 microfarads is merely illustrative rather than restrictive. This graph illustrates a total of eight different examples in which there are from one to eight line capacitors, that yield different amperage results. In these examples, a combination of these different eight capacitors has been utilized to achieve the lowest values as shown in FIG. 15. Of course, more or fewer capacitors may be used, as will be seen in the description of further figures described below. In this example, as the tuning occurs, the input amperage continues to go down, for example from 7 amps for one line capacitor down to 22 amps when in combination with other line capacitors. In the last example, where there are eight line capacitors, the initial value of amperage is approximately 22 Amps, which falls dramatically down to approximately 7 amps with the use of four line capacitors. In other words, this logic flow goes through all configurations of the capacitors automatically until the lowest values are achieved and then it stops returning through the loop. Otherwise, it would continue to retune until it gets to the lowest setting.

Looking next to FIG. 16, a schematic diagram of the electrical connections is shown with a pair of contactors 120, for both the power and the auxiliary, being 3 phase, 150 A, 240 VAC coil, and a third contactor 122, 3 phase, 50 A, 240 VAC coil, in electrical communication with the current transformer 214, auxiliary controller, and once the switches are closed, main controller 218. The current transformer 214 measures the current coming into the system. The pair of contactors 120 is for the motor side of the circuit. The third contactor 122 clicks the capacitors on and off.

In the on position, when contactors 120 are closed, they may be in electrical communication with MOV blocks 146, being 275 VAC. Contactor 122 may also have an MOV block to provide non-linear characteristics for surge protection and surge arresting. Controller 184 is operated with a switch 186 and proper tuning is indicated by tuner light 188. Capacitor bank 162 includes line capacitors 142, 100 μF, 377 VAC tuning. Line capacitor bank 162 includes combinations of running capacitors, power factor capacitors and starting capacitors, while motor capacitor bank 164 also includes combinations of running capacitors, power factor capacitors and starting capacitors, as described earlier with reference to the Examples. Preferably, each of the capacitors includes two breakers, a separate breaker as well as a built-in breaker. Further, the capacitors may include built-in relays in addition to the separately shown relays.

In this automatically adjusting tuning system, the motor capacitors may include the shown configuration of eight (8) running capacitors and eight (8) power factor capacitors, although the desirable number of capacitors maybe selected depending upon the situation. Each of these capacitors may be from about 5 μF to about 100 μF for the line and motor capacitors, and from 100 VAC to 500 VAC, whether they are fixed or adjustable. A separate bank of starting capacitors, may be attached to the motor, and may consist of capacitors from 500 μF, 100 VAC 1000 microfarad, preferably 700 μF, 377 VAC.

The power source sends a signal to controller 184 and then tunes the system. Controller 184 tunes the system by reading the current, and then determining how to tune continuously as the load changes on-the-fly. The electrical circuit senses the DC voltage and the amperage, and when the amperage value is at the lowest, the system is tuned and ready to receive additional loads put on by additional motors. In the present example, a single 75 hp motor was utilized, although better results are achieved by any increasingly powerful motors.

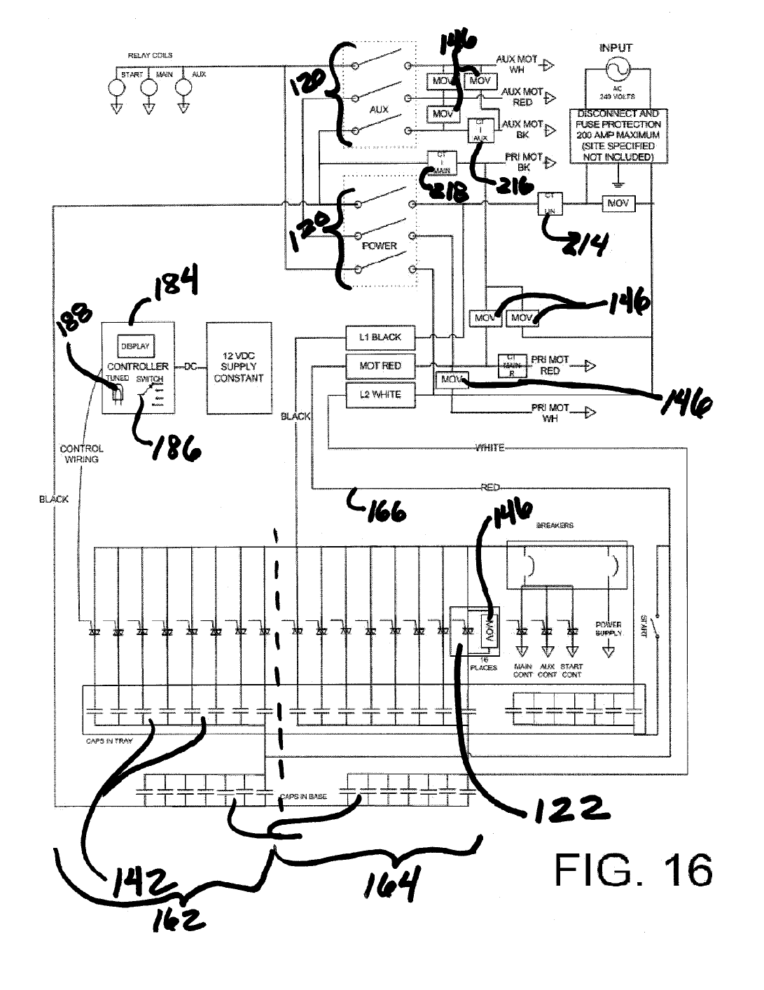

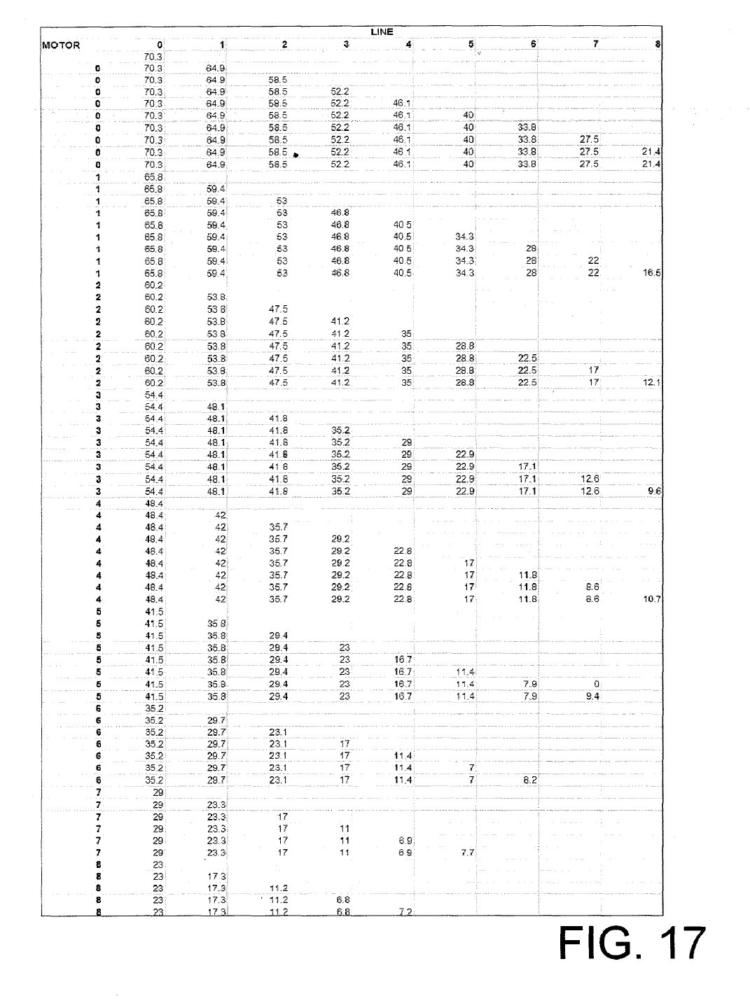

FIG. 17 is a line chart showing the decrease in amperage input over time as the various combinations of capacitors are tested throughout the lines. The values are given in amps, and initially start out at 70.3 A at the input, and show the lowest levels of required amperage at 6.8 A.

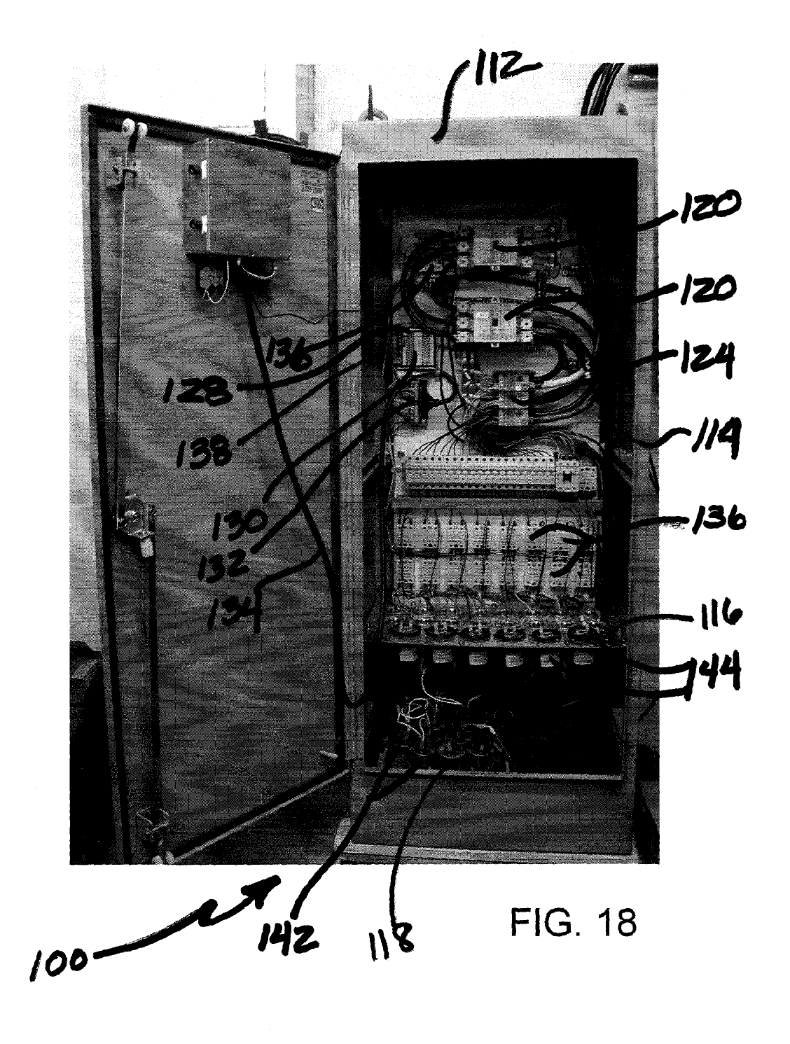

FIG. 18 shows the energy system, generally denoted by numeral 100, enclosed by a steel enclosure 112 having an inner steel panel 114 two how was energy system 100. An upper capacitor shelf 16 is located above lower capacitor shelf 118. These shelves are configured to hold the banks of capacitors that are used in practicing the present invention. In this example, a pair of three phase 150 amp 240 VAC coil contactors 120 are shown at the top of the box, in electrical communication with a triple power block 124, (2 in, 15 out). Power supply 128 is electrically connected to the rest of the circuit, and it includes a power supply 240 AC-12 V, DIN mount. Although this is the preferable power supply, other supplies would be suitable. Power supply 128 includes a circuit breaker 130, 10 A, DIN mount for safety. Connector block 132 is preferably a 40 pole, DIN mount unit to connect all of the other components. An interface cable 134 connects the controller to the block. Relays 136 are solid-state 480 VAC, zero cross, 5 VDC units for electrically connecting the line and motor capacitors through to the breakers.

Still looking at FIG. 18, there is shown a series of line capacitors 138 that is most useful in accordance with the present invention. These capacitors include running and power factor capacitors having values similar to the previous examples, although they have been applied in this automatically adjustable system. Likewise, capacitors 140 are power factor capacitors on the line side and include values previously discussed. Motor capacitors 142 are starting capacitors in this example, using 700 μF 377 VAC capacitors. The brand name and commercial availability of all of these capacitors has been discussed hereinabove with regards to the earlier examples and are incorporated herein by reference.

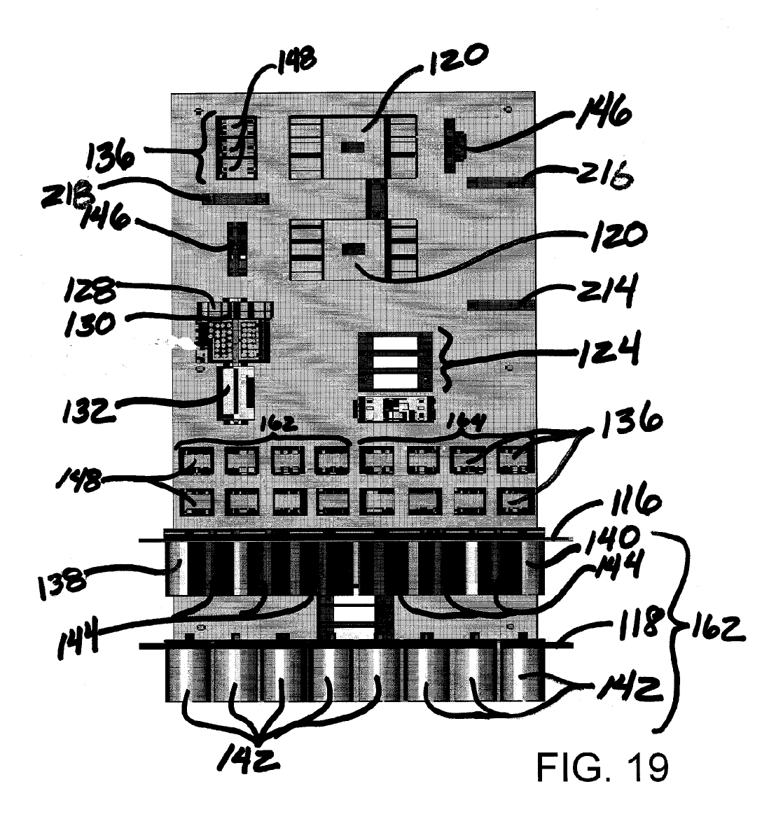

Referring now to FIG. 19, there is shown a block schematic diagram of the various components of the automatically adjustable tuning energy-saving device of the present invention. A pair of contactors 120 and a third separate contactor 122 have varying values, three phase 150 A and 50 A, 240 VAC coil construction, respectively, in electrical communication with motor, auxiliary and starting capacitors. Power supply 128 includes a circuit breaker 130 and is in electrical communication with connector block 132 by interface cable 134. In this example, there are 19 relays, 16 of them in one bank above the capacitors, and three of them up in electrical communication with 275 VAC MOV discs to protect relay searches. The MOV discs may have other suitable values, but were used here for their nonlinear characteristics.

FIG. 19 illustrates the relative placement of the capacitor banks 162, including eight motor capacitors, including running and power factor capacitors, used in the tuning process. Starting capacitors 142 may be arranged in any number, and trays of capacitors may be added onto the starting capacitor bank depending upon the application. Line capacitors 138 and motor capacitors 140, of which include running and power factor capacitors each include a dual breaker system, both separate and built-in. Relays 136 include MOV discs 148, as described above. Current transformers 214, 216, and 218, are current, auxiliary and main controllers respectively, as each measure current as it circulates through the electrical circuit shown. In this particular example, the line side capacitors 162 and the motor side capacitors 164 are side-by-side and contained similar components.

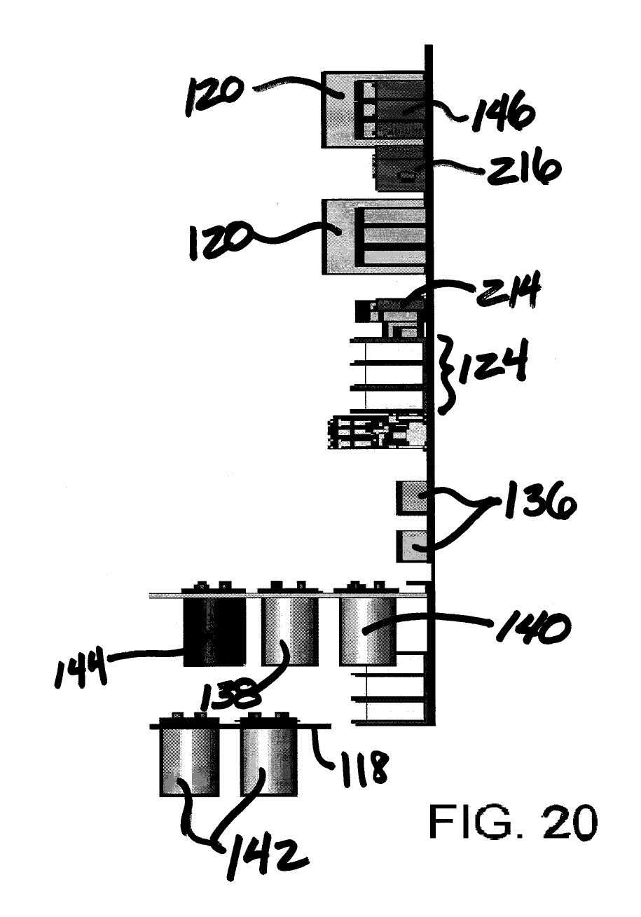

FIG. 20 is a side elevational view of the block diagram illustrated in FIG. 19. Controllers 120 include MOV blocks 146 and are controlled by auxiliary controller 216. Current transformer 214 is located on top of power block 124, with relays 136 thereunder. Starting capacitors 144 are located at the front of the tray including the running and power factor capacitors 138 140. An additional tray 118 of capacitors 142 is located at the bottom, and may accommodate any number of trays of additional capacitors.

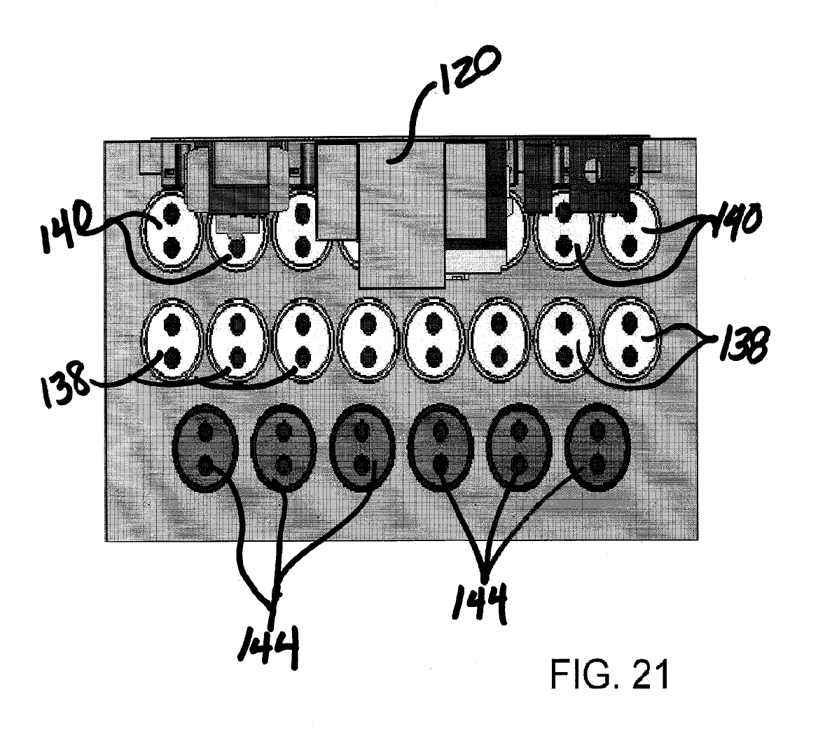

FIG. 21 is a top plan view of the relative placement of the starting capacitors 144, the running and power factor capacitors 138 and 140. Three phase contactor 120 is shown extending outwardly from the back of the energy device box.

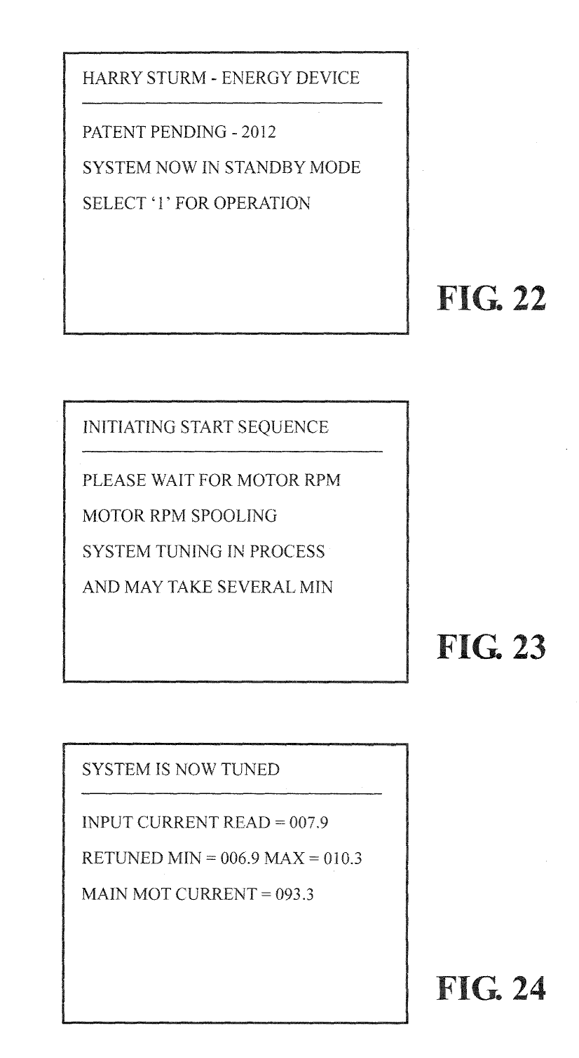

With combined reference to FIG's 22 through 24, a computer screen readout is shown which is displayed during the tuning procedure. Initially, FIG. 22 illustrates the opening screen showing the system in standby mode, while FIG. 23 shows the initiation of the start sequence where the system is tuning in this process. After a few minutes, FIG. 24 shows screen readout “System is now tuned”, and the operator can see that the input current reading is 7.9 A while the main current output of 93.3 A.

Since the values of the input current and output current change depending upon the automatic adjustability of the system, it may be noted that generally the input current is from one third (⅓) to one 100^{th} ( 1/100) of the output current. Under certain extreme conditions, the input current is less than one amp, with an output current of more than 75 amps. Any form of input current is suitable for starting the motors, and then the motors provide current at a much higher value. Because this energy-saving device can yield so many experimental results, we have attempted to provide a wide range of examples of utilizing various forms of capacitors to provide at least one energy producing induction motor, that when coupled to the electric grid, any number of motors can be added to increase the output with the unusual characteristic that under certain circumstances, fully described here in above, have a much smaller electrical input requirement to achieve a dramatic electricity output.

In other words, once an induction motor is started using the energy-saving device of the present invention, adding additional motors to the system and putting additional loads on those motors causes the required amperage input to decrease significantly. Our initial examples illustrate that by utilizing the capacitor configuration described above, any number of induction motors will output more electricity than the input.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto.

### INDUSTRIAL APPLICABILITY

The present invention finds industrial applicability in energy saving devices, and especially in providing high electrical output while consuming low electrical input.

What is claimed is:

1. An energy-saving device, comprising:
at least one starting capacitor;
at least one running capacitor; and
at least one power factor capacitor,
all in electrical communication with a power supply and at least one induction motor,
wherein the power supply needs to supply a much smaller input than the output current of the at least one induction motor after the induction motor has been running for at least from one second to about 30 minutes.

2. The energy-saving device of claim 1, wherein the at least one starting capacitor includes at least five starting capacitors.

3. The energy saving device of claim 1, further comprising an MOV disc to suppress relay surges.

4. The energy-saving device of claim 1, wherein the at least one induction motor includes induction motors having power ratings from 5 hp up to 1000 hp.

5. The energy-saving device of claim 1, wherein the much smaller input is from about 1.8 A to about 118 Å.

6. An energy-saving device, comprising:
at least one starting capacitor;
at least one running capacitor; and
at least one power factor capacitor,
an automatically adjustable tuning system with computer algorithms for progressively interconnecting said starting, running and power factor capacitors to achieve the lowest possible input,
all in electrical communication with a power supply and at least one induction motor,
wherein the power supply is tuned to need a much smaller input than the output current of the at least one induction motor after the induction motor has been running for at least from one second to about 30 minutes.

7. The energy-saving device of claim 6, wherein said automatically adjustable tuning system with computer algorithms interconnects from about four to about 100 starting, running and power factor passengers to achieve the lowest possible input of electrical energy in order to power the at least one induction motor to achieve a high electrical output in relation to the low electrical input.

8. The energy-saving device of claim 6, wherein said at least one induction motor includes two or more motors having a horsepower rating of from about 5 hp to 1000 hp.
